(19) United States
(12) Patent Application Publication
(10) Pub. No.: US 2007/0174102 A1
(43) Pub. Date: Jul. 26, 2007

(54) METHOD AND SOFTWARE FOR SELECTING SECURITIES FOR INVESTMENT

(76) Inventor: Greg Coulter, Calgary, Alberta (CA)

Correspondence Address: VERMETTE & CO., SUITE 320 - 1177 WEST HASTINGS STREET, VANCOUVER, BC, V6E2K3, CA

(21) Appl. No.: 11/308,714

(22) Filed: Apr. 25, 2006

Related U.S. Application Data
(60) Provisional application No. 60/766,466, filed on Jan. 20, 2006.

(51) Int. Cl. G06F 15/02

(52) U.S. Cl. 705/9; 434/107

(57) ABSTRACT

A method and software for selecting a portfolio of securities for investment purposes, which consistently provides a superior return to the market. Companies are evaluated and ranked according to data reflective of their level of employee commitment. Securities of companies having a high level of employee commitment are selected for inclusion in the portfolio. Medium and long-term returns for the portfolio are compared to market indices to evaluate performance. A computer may be used to carry out one or more of the steps of the invention.

### RELATED APPLICATIONS

This application claims the benefit of U.S. Provisional Patent Application No. 60/766,466 filed on Jan. 20, 2006.

### BACKGROUND OF THE INVENTION

There are a large number of known investment strategies. Ideally, investment strategies should have three inherent qualities:
1. they seek to out-perform specified indices by selecting portfolios using sound, fundamental screens that reflect the historical behavior of the securities;
2. they show back-tested results and have staying power even through bear markets; and
3. they dictate what stocks are chosen for the portfolio, no emotional judgments are made and the strategies remain constant over time.

There are a number of issued patents that utilize mathematical and statistical methods to build strategic investment processes. The purpose of these processes is to generate better financial performance, generally measured as the return on investment (e.g. yearly improvement in stock price).

In other words, everyone wants to find a way to try and beat the market, as measured by various market indices (e.g. the S&P 500 and S&P 300 indices). However, this is very difficult and, as a result, more than 80% of the actively managed investment portfolios under perform the indices in any given year. The statistics show that it is virtually impossible to pick individual stocks that will outperform the market over a 1, 3, or 5-year period.

Accordingly, there is a need for a method of building a securities portfolio that will reliably outperform the market.

### SUMMARY OF THE INVENTION

The present invention generally relates to a methodology for selecting a securities portfolio for investment. More particularly, the present invention relates to a method for selecting a securities portfolio based on one specific criterion; employee commitment (sometimes also referred to as employee engagement). A company having high employee commitment is generally regarded as an ‘excellent company to work for’ by the rank and file employees based on the company's management and human resources practices. In other words, the present invention involves the evaluation of the level of employee commitment for a given pool of companies and the inclusion in an investment portfolio of the securities of those companies having the highest levels of employee commitment.

The invention essentially comprises the following general steps:

Defining a pool of companies;

Determining the level of employee commitment for those companies in the pool;

Selecting those companies having a level of employee commitment above a threshold;

Determining the average annual compound rate of return (a.a.c.r.r.) for the selected companies;

Comparing the a.a.c.r.r. of the selected companies to the corresponding a.a.c.r.r. for appropriate market indices;

Including at least some of the selected companies having the highest relative a.a.c.r.r. in a portfolio; and

Purchasing securities of the companies included in the portfolio.

Any one or more of the above steps may be carried out on, or with the aid of, a computer. The method may also be carried out by software.

One objective of the present invention is to provide an above average total return from the portfolio by investing in the securities of companies that are regarded by their employees as an excellent company to work for (i.e. companies that have high employee commitment).

A second objective is to reduce the risk of the portfolio by achieving proper diversification across industries, asset classes, and stock exchanges.

A third objective of the present invention is to minimize the amount of ‘portfolio management’ that is required. This will reduce the Management Expense ratio (MER), which in turn will further improve the (net) return that the portfolio provides to the investors.

A fourth objective of the present invention respects the views of a large target market—the trustees of single- and multi-employer pension plans (e.g. union pension plans). Such pension plans, and similar institutional investors, often require that their investments be ‘Labor Acceptable’ (more details below).

An investment portfolio according to the present invention will preferably consist of a diversified group of stocks and other securities that will generally remain relatively fixed for a predetermined period of time. As new companies are reviewed and determined to have the requisite level of employee commitment, securities of those companies may be added to the portfolio. Once a security is added to the portfolio it will generally remain in the portfolio until the occurrence of one or more events such as, but not limited to:
1. merger with or acquisition by a company having low employee commitment;
2. change in management;
3. a significant drop in the level of employee commitment;
4. in the case of ‘Labor Acceptable’ portfolios, an additional criterion may be applied based on a determination by labor organizations that a company is anti-union (e.g., the view of a number of trade unions in both Canada and the United States that Wal-Mart is anti-union);

and/or
5. poor financial performance as determined by conventional investment criteria.

The present invention enables the selection of securities based upon the perception of employees as to how their company performs on a number of ‘employee commitment’ criteria. Those companies having the highest ‘employee commitment’ consistently outperform the market indices.

The view of financial analysts, competitors, market watchers, etc. need not be considered at any point during the analysis.

The invention can also be embodied as a computer readable medium bearing a computer program containing instructions which, when implemented by a general purpose computer, causes the computer to carry out some or all of the various steps of the invention described herein.

In one embodiment, the invention is a computer readable medium bearing a computer program containing instructions which, when implemented by a general purpose computer, causes or enables the computer to (a) receive data identifying companies in a user-defined first pool of publicly traded companies; (b) receive employee commitment data of regarding the companies in the pool; (c) determining which companies in the first pool have a level of employee commitment in excess of a predetermined threshold, wherein the companies exceeding said predetermined threshold make up a second pool of companies; (d) receiving financial data reflective of historic values of stocks of the first pool of companies and historic performance of at least one related market index; (e) calculating from said financial data an annual compound rate of return for the first pool of companies and for the market index; (f) determining which stocks from the first pool have an a.a.c.r.r. exceeding the a.a.c.r.r. of the market index, wherein the companies having stocks that have an a.a.c.r.r. exceeding the a.a.c.r.r. of the market index make up a third pool of companies; and (g) identifying a fourth pool of companies made up of companies that are in both the second and third pools, wherein the stocks of the companies in the fourth pool may be selected for inclusion in an investment portfolio.

In an alternate embodiment the invention is a computer implemented method for enabling a user to create an investment portfolio comprising: (a) receiving company identification data from the user, wherein the company identification data identifies a pool of companies; (b) receiving employee commitment data from the user, wherein the employee commitment data reflects the level of employee commitment of the companies in the pool; (c) receiving financial data from the user, wherein the financial data reflects historical values of the stocks of the companies in the pool and historical values of at least one corresponding market index; (d) based on the employee commitment and financial data, identifying stocks from the pool of companies to be owned directly by the user.

In a further alternate embodiment the invention is a method of using a computer to select securities for an investment portfolio by (a) defining a pool of publicly traded companies; (b) collecting data indicative of the levels of employee commitment of the companies; (c) collecting financial data on the companies and for at least one relevant market index, wherein the financial data includes an annual compound rate of return for securities of the companies and for the market index; (d) selecting for inclusion in an investment portfolio at least some of the securities from the companies having the highest annual compound rate of return and the highest level of employee commitment, wherein at least one of these steps is carried out by a computer.

In yet another embodiment the invention is a computer-readable medium bearing a computer program containing instructions which, when implemented by a computer, cause the computer to carry out the steps of: (a) receiving data indicative of levels of employee commitment of a pool of companies; (b) receiving financial data for the companies and for at least one relevant market index, wherein the financial data includes an average annual compound rate of return for securities of the companies and the market index; (d) ranking at least some of the companies according to employee commitment and financial data, to form a group of ranked companies; and (e) selecting at least some the securities from the group to form an investment portfolio; wherein at least one of the steps of collecting, ranking, and selecting is carried out by a computer.

Any one of the above computer or software implemented embodiments of the invention may include a step wherein: the employee commitment data is compared to a predetermined threshold; a predetermined number of securities are selected; at least some of the securities are purchased; equal percentages or dollar amounts of securities are purchased; the employee commitment and financial data are obtained from publicly available sources (e.g. Fortune™ Magazine, Macleans™, Report on Business™, etc.).

### DETAILED DESCRIPTION OF THE INVENTION

There are a number of annual surveys that purport to measure whether a company has high employee commitment. Some of the data from these surveys may be incorporated into the method of the present invention. The critical point(s) when reviewing the results of a methodology that presumes to measure the employee commitment of a company is that (1) the methodology must measure employee commitment from the perspective of the rank and file employees, not management and (2) ‘employee commitment’ must be broadly measured. Useful discussions of employee commitment and related issues may be found in the following publications:
1. “Employee Engagement: Business Buz or Serious Business,” presentation delivered at the IABC 2005 International Conference, 26-29 June, Washington, D.C., by Susan Suver, VP Global Human Resources for Arrow Electronics, Inc., (the presentation may be viewed at www.iabc.com/conf2005/).
2. “From Attraction/Retention to Financial Results, 50 Best Employers Outshine the Competition, Says Hewitt Associates”, Jan. 3, 2005, available at http://was4.hewitt.com/hewitt/).
3. “The Impact of Human Resource Management Practices on Turnover, Productivity, and Corporate Financial Performance,” Huselid, M. A., (1995) Academy of Management Journal, 38, 635-672.
4. “Are the 100 Best Better? An Empirical Investigation of the Relationship Between Being a ‘Great Place to Work’ and Firm Performance,” Fulmer, I., Gerhart, B., and Scott, K. S., Personnel Psychology, Winter 2003.
5. “A Longitudinal Study of Quality of Work Life and Business Performance,” May, B. E. and Lau, R. S. M., South Dakota Business Review, Dec. 1, 1999.

It is cliché to state that ‘a company is as good as the people that work there’. However, since every company will have superstars, average performers, and under performers, it begs the question why do some companies significantly outperform their competitors? In the 1995 article entitled “The Impact of Human Resource Management Practices on Turnover, Productivity, and Corporate Financial Performance”, (Rutgers University, 1995) Dr Huselid establishes a positive correlation between HR practices that engage or encourage employees, or commit employees to their company, and improved financial performance (sales, gross profit) of the company.

My analyses of companies with high employee commitment show that they consistently have financial performance (defined as return on their stock) that outperforms both their competitors and the respective financial markets and market indices (e.g., S&P 500-NYSE; S&P 300-TSE.).

One embodiment of the invention is useful for selecting securities from amongst the companies that are publicly traded, (for example, on the New York, NASDAQ, London, Tokyo or Toronto Sock Exchanges) for an investment portfolio (these exchanges are discussed by way of example only, the present invention contemplates the selection of securities traded anywhere in the world). The first step of such embodiment is to define the universe or pool of securities for potential investment, for example, those companies whose securities are traded on the New York Stock Exchange. Alternatively, a smaller group of companies whose securities are traded on the Exchange may be defined. Once a pool of companies has been defined, the next step is to determine the level of ‘employee commitment’ of each of the companies in the pool.

Quantyfying Employee Commitment

Below is a non-exhaustive description of the criteria that determine the level of employee commitment in a company. A company having high employee commitment will generally have very good practices relating to Performance Management, Pay and Benefits, Promotions, Professional Development, Communication, and Working Environment. Each criterion is briefly described, and followed by sample questions intended to measure that criterion.

Performance Management

Performance management refers to a participative process between managers and employees, which ideally includes a self-evaluation process. In a company having good Performance Management, individual and team objectives are linked to the business objectives and feedback is provided to employees on their performance (for both core competencies and organizational values). This feedback is preferably done in a constructive fashion and on an ongoing basis. It is a powerful tool for addressing the underperformers, and identifying the high performers. The high performers can then be career managed by providing them with accelerated learning opportunities to achieve their potential.

In companies having good Performance Management, employees are empowered to make decisions based on a clear understanding that they support the company's culture and business objectives. They are held accountable for their decisions and actions. ‘Errors’ are viewed as a learning opportunity. There is an open door policy that allows employees to question decisions that they believe are inconsistent with the company's values or business objectives. Employees are provided with logical, factual explanations and it is acceptable to ‘agree to disagree’.

Sample questions measuring Performance Management:
1. Do employees receive a formal performance appraisal at least once per year?
2. Do employees complete a self-assessment as part of the performance appraisal process?
3. In the performance appraisal process, do managers actively solicit input from others in the organization that the employee interacts with?
4. Does the Company have a formal ‘upwards evaluation ‘process (i.e. employees rate managers)?
5. Is there an established process to appeal/question the validity of performance appraisal?
   Pay and Benefits

Pay and Benefits generally refers to the compensation received by employees. Both financial and non-financial types of compensation are considered in evaluating the Pay and Benefits. In companies having good Pay and Benefits, compensation is ‘fair’; there are salary bands so that individuals doing work of equal value are paid equitably. Pay for performance is the driver behind the salary review process. All employees share in the financial success of the company (e.g., all employees are bonus eligible). Individual and team successes are celebrated in a visible fashion that is viewed as desirable by the employee(s).

Sample questions measuring Pay and Benefits:
1. Is pay linked to performance?
2. Are there established pay grades using a recognized rating system (e.g., Hay, IPE, etc.)?
3. Are bonuses paid?
4. Are bonuses paid below the manager/supervisor level?
5. Are health benefits provided?
6. Are employees satisfied with the health benefits?
7. Is there a pension plan?
8. Are employees satisfied with the pension plan?
9. Are employees satisfied with the salaries?
10. Is there high employee turnover?
   Promotions

The Promotions practices of a company are an important component of employee commitment. The preferred method to fill vacancies is through internal promotion. Preferably, the evaluation of candidates is fair, just and equitable (no discrimination, no favoritism). The company actively seeks opportunities for continuing education and job secondments to both broaden and deepen an employee's technical and behavioral skills. Companies having good Promotions practices are likely to have leadership development programs in place internally to help achieve these goals. Such companies may also utilize behavioural development interviewing (BDI) to helps ensure that potential employees have the correct behavioural skills to fit into the corporate culture.

Sample questions measuring Promotions practices:
1. Are the majority of promotional opportunities filled internally?
2. Are employees advised of promotional opportunities?
3. Are performance appraisals considered in the selection process?
4. Are all qualified employees given the opportunity to be interviewed?
5. Are unsuccessful candidates provided with feedback?
   Professional Development

Companies having good Professional Development practices actively seek opportunities for continuing education and/or job secondments to both broaden and deepen employees’ technical and behavioral skills.

These companies are likely to have leadership development programs in place internally to help achieve these goals.

Sample questions measuring Professional Development practices:
1. Does the company have a dedicated budget for professional development?
2. Is professional development a topic of discussion during the performance appraisal process?
3. Is there a clear process/policy for applying for professional development opportunities?
4. Do the majority of employees receive at least 8 hours of professional development per year?
   Communication

Companies having high employee commitment must have good Communication. In this context, Communication refers to the communication between employees and management, subordinates and superiors. In particular, it refers to communication of the goals and objectives of the company and what roles the employees and managers are expected to play. Preferably, employees’ ideas are actively solicited, and management provides feedback to the suggestions that are brought forward. There is genuine discussion on the issues of importance to the employees.

Communication also comes into play during the orientation process to ensure new employees are indoctrinated into the company culture and goals. Efforts are also made to ensure that employees have sufficient opportunities to provide and be given feedback.

Sample questions measuring Communication practices:
1. Do employees receive information about company performance (e.g. sales, profit, challenges, new opportunities, etc.)?
2. How often do employees receive information about company performance?
3. Does the company have organizational ethical values?
4. Does senior management lead by example (i.e. model the organizational values)?
5. Is there a process for sharing customer feedback with employees?
   Working Environment

Working Environment refers to the quality of the working environment.

In companies having a good Working Environment, employees believe that they are treated in a fair, equitable and just fashion by management, and there is a high level of mutual trust between employees and company executives. The employees believe in the products and services that the company provides. The work environment is healthy and safe. The company is consistent in how it responds to issues. Further, they do what they say they will do (i.e. their actions are aligned with their promises). They are transparent in their business dealings, as they have nothing to hide. The companies recognize that legitimate ‘personal issues’ (e.g. family illness, etc.) will arise that cause a conflict with work commitments. They behave in such a way that the employees know that looking after the personal commitment is the first priority.

It is a result of a number of things including management demonstrating a basic respect for the men and women who come to work every day.

Sample questions measuring the quality of the Working Environment:
1. Does middle management treat the employees with respect?
2. Does upper management treat the employees with respect?
3. Are employees proud to work for the company?
4. Do employees consider the company to be the best they have ever worked for?

To accurately ascertain whether or not a company has high employee commitment it is necessary to get sufficient feedback from all of the employee groups (e.g., union & non union, ‘workers’, managers, and executives, full time and part time, casual & permanent, various geographical locations—a true cross sample of all the employees). The use of a survey incorporating the factors listed above is an efficient means to accomplish this requirement.

It is also important to ensure that the survey is distributed randomly. For example, an ‘all employee’ list can be generated, (preferably in a spreadsheet such as Microsoft Excel® so it can be easily manipulated) which is then sorted alphabetically by the employees' last names. A number between 1 and 7 is chosen at random. Assume it is number 6. The 6^{th} employee on the list receives a survey. Then, every 7^{th} employee thereafter (e.g., number 13, 20, 27, etc.) receives a survey until the list is exhausted. This minimizes the ability of a company to try to influence which employees receive the survey. If every 7^{th} employee gets a survey, (i.e. 14% of the employees) then a 40% response rate will yield responses from 5.7% of the employee population. Statisticians generally accept a 5% overall response rate as being statistically significant. Preferably, the response rate is approximately 60% or more of the surveys are returned. The higher the response rate the more reliable the results.

The survey is preferably short enough that employees can complete it in a relatively short period of time (e.g. less than 15 minutes) but extensive enough to give an accurate indication of the level of employee commitment. The survey may be carried out in any of a number of ways (e.g. by distributing written questionnaires to be filled out by employees, as an online form to be filled out by employees, as a form that is emailed to employees, in-person interviews with employees, phone interviews with employees, etc.).

Below is a sample written survey, designed to measure Employee Commitment:

Performance Management
1. Are you held accountable for the decisions you make?
2. Do you receive a formal performance appraisal at least once per year?
3. Does your manager actively solicit input from others in the organization before writing your performance appraisal?
4. If you do not agree with your manager's evaluation of your performance, is there an appeal process?

Pay and Benefits
1. Do you get a bigger pay increase if your performance is better than the average employee?
2. Are there established pay grades using a recognized rating system (e.g., Hay, IPE, etc.)?
3. Are bonuses paid below the manager/supervisor level?
4. Are you satisfied with the health benefits that you receive?
5. Is there a pension plan?
   Promotions
1. Is ‘fitting into the company culture’ an important consideration when recruiting new employees?
2. Are the majority of promotional opportunities filled internally?
3. Are all qualified employees given the opportunity to be interviewed?
4. Are unsuccessful candidates provided with constructive feedback?

Professional Development
1. Is professional development discussed during the performance appraisal process?
2. Is there a clear process/policy for applying for professional development opportunities?
3. Do you receive at least 8 hours of professional development per year?
   Communication
1. Do employees receive information about company performance (e.g. sales, profit, challenges, new opportunities, etc.)?
2. Do you have regular meetings (at least twice per year) with your senior manager at which you can ask questions?
3. Does the company have formally stated ethical values?
4. Does senior management abide by these ethical values?
5. Are new employees coached on the importance of following the company culture?

Working Environment
1. Does your boss treat you with respect?
2. Do you receive paid time off to take your dependent children to medical appointments?
3. Are you proud to work for this company?
4. If senior management makes a promise to the employees, do they keep it?

There are a total of 25 questions on the above example survey, which meets the criteria set out above (i.e. employees can preferably complete it in less than 15 minutes). A longer or shorter survey could be used depending on the circumstances.

In order to determine whether a given company or pool of companies has the requisite level of employee commitment for investment purposes, a threshold level of employee commitment must be established. The higher the threshold, the better the level of employee commitment, however, the smaller the number of qualifying companies is likely to be. Therefore, the next question that must be addressed is ‘what is the threshold for being considered a company with a high level of employee commitment’?

The first step is to calculate the average score of all of the surveys for each given company. The average scores of the companies are then compared to the threshold in order to determine whether they have the requisite level of employee commitment.

In the preferred embodiment, the threshold is relative. For example, the companies scoring in the top 10% for employee commitment may be deemed to have met the threshold. The threshold can be set at 20%, 5%, 50%, etc., according to factors such as the number of companies being evaluated, the number of companies to be included in the portfolio, etc. Alternatively, a user may simply want to select the companies having the 10 top scores.

In addition to a relative threshold of employee commitment, an absolute threshold may be used. For example, those companies having an average of 90% “yes” responses to the above example survey may be deemed to have the requisite level of employee commitment. Alternatively, the threshold could be set at 80%, 50%, 75%, etc.

Whether a relative or absolute threshold is used, it can vary according to the circumstances. If a user of the present invention wants to identify only those companies with the very highest level of employee commitment, then the threshold can be set high. If a user instead wants to identify companies having above average employee commitment, a lower threshold can be set. Similarly, if a large pool of companies is being analyzed, it may be necessary to set a high threshold in order to reduce the number of companies qualifying as having “high employee commitment.” If the same pool of companies is evaluated repeatedly over a period of time, historical factors may also help to determine the threshold level, (e.g. if the present method is being applied to a pool of companies that have consistently high levels of employee commitment, it may be necessary to set a high threshold).

To test the above example survey, individuals employed at six different publicly traded Canadian companies were asked to complete it. 3 companies scored 80%+ (i.e. 80% “yes” responses) and 3 companies scored less than 80%. The 3 that scored higher than 80% were Telus, Pan Canadian Oil and Gas, and Royal Bank. Their (historical) stock results were examined for the period of September 2000 to September 2005—all 3 significantly outperformed both the S&P 500 (NYSE) and the S&P300 (TSE), (see Tables 1 through 3 below). The historical stock results of the 3 companies that scored less than 80% were also examined. 2 of the 3 companies underperformed the indices; the 3^{rd} company was 0.2% above the average of the 2 indices.

The key in calculating the score on the survey is the number of ‘yes’ answers, since ‘no’, ‘not applicable’ and blank answers do not indicate high employee commitment.

The example survey above is written in the form of “yes/no” questions.

Another common way to construct such surveys is to ask participants to answer using a number scale, (e.g. on a scale of 1 to 5, where 5 is “Strongly Agree” and 1 is “Strongly Disagree”). Such number scale surveys can be scored by adding up the numbers chosen for the responses. Whether companies have the requisite level of employee commitment is determined by comparing the average scores to a given threshold or by selecting the top X % of the companies having the highest scores, (or perhaps the lowest scores; depending whether 1 or 5 indicates high employee commitment for each of the questions in the survey, a low average score may also indicate high employee commitment).

Alternatively, surveys conducted using a number scale could be scored similar to a yes/no survey. For example, ‘strongly agree’ and ‘agree’ answers are counted as 1 point (indicating the presence of one of the criteria discussed above for determining employee commitment). All other answers, “neutral”, “disagree” and “strongly disagree”, are counted as 0 points. To illustrate, a 25 question survey (potential of 25 points) with the following results is considered:
Strongly agree—10 answers; Agree—6 answers; Neutral—2 answers; Disagree—1 answer; and Strongly disagree—6 answers. The score on this survey is 16 out of 25—an average of 64%.

Based on the example survey discussed previously, in the period from September 2000 to September 2005 the following Canadian companies were determined to have high employee commitment:

Telus, Pan Canadian Oil and Gas, and Royal Bank. All three companies are publicly traded, and the shares of all three significantly outperformed both the S&P 500 and the S&P 300 over the period September 2000 to September 2005, as shown in the following tables.

TABLE 1
% per annum average annual rate of return for the period
Sept 2000 to Sept 2005

| | |
|---|---|
| S & P 500 Index (NYSE) | −2.7 |
| S & P 300 (TSE) | 2.5 |
| Telus, Pan Canadian Oil and Gas, | 15.0 |
| and Royal Bank Portfolio | |

Table 1 is a comparison of the historical 5—year (June 2000 to June 2005) average annual compound rate of return of (a) a portfolio of Telus, Pan Canadian Oil and Gas, and Royal Bank stocks, (b) the S&P 500 Index—NYSE, and (c) the S&P 300 Index—TSE.

TABLE 2
% per annum average annual rate of return for the period
Sept 2001 to Sept 2005

| | |
|---|---|
| S & P 500 Index (NYSE) | 1.3 |
| S & P 300 (TSE) | 9.9 |
| Telus, Pan Canadian Oil and Gas, | 22.0 |
| and Royal Bank Portfolio | |

Table 2 is a comparison of the historical 4-year (June 2001 to June 2005) average annual compound rate of return of (a) a portfolio of Telus, Pan Canadian Oil and Gas, and Royal Bank stocks, (b) the S&P 500 Index—NYSE, and (c) the S&P 300 Index—TSE.

TABLE 3
% per annum average annual rate of return for the period
Sept 2002 to Sept 2005

| | |
|---|---|
| S & P 500 Index (NYSE) | 11.0 |
| S & P 300 (TSE) | 9.9 |
| Telus, Pan Canadian Oil and Gas, | 23.0 |
| and Royal Bank Portfolio | |

Table 3 is a comparison of the historical 3-year (June 2002 to June 2005) average annual compound rate of return of (a) a portfolio of Telus, Pan Canadian Oil and Gas, and Royal Bank stocks, (b) the S&P 500 Index—NYSE, and (c) the S&P 300 Index—TSE.

Based on the above brief analysis, shares of Telus, Pan Canadian Oil and Gas, and Royal Bank Portfolio appear to be qualified candidates for inclusion in an investment portfolio.

There are a number of publicly available publications that purport carry out an analysis analogous to the one described above. Business publications such as Fortune™ Magazine, Report on Business™, MacLean's™ periodically publish issues identifying and discussing which companies are the best to work for (see, for example, the Jan. 23, 2006 issue of Fortune™ Magazine). Similar data may be available from other publications or from various business, industry or consumer groups, as well as governmental or intergovernmental agencies and organizations (e.g. unions, agencies of the U.S. state and federal governments, the U.N., etc.). The methods and data of these groups and publications will vary, however, to the extent that that they reflect a measurement of employee commitment, they can be used in the present invention. For example, rather than carrying out a survey to assess the levels of employee commitment in a pool of companies, the data or results gathered and published by Fortune™ Magazine may be used. Alternatively, information from such publications can be used to supplement the methods of the present invention.

Periodic Review

On a periodic basis (e.g. annually) the portfolio of securities of companies having high employee commitment is reviewed.

In a preferred embodiment, the securities of the existing companies in the portfolio have both their 1 and 3 year average annual compound rate of return (a.a.c.r.r) calculated. Securities of ‘new’ companies (i.e. newly determined to have the requisite threshold level of employee commitment for inclusion in the portfolio) also have their 1 and 3 year a.a.c.r.r. calculated. The securities of the existing and new companies are then ranked from 1 to N based on their annual rates of return (with 1 being the security with the highest return). This analysis is done for both the 1- and 3-year returns.

The two rankings (1 year and 3 years) are then added together to determine the ‘total ranking’ (e.g., if a company ranked 5^{th} on the 1 year return and 12^{th} on the 3 year return, they would have a ‘total ranking’ of 17 points (5+12).

The companies are then sorted based on their total ranking. The top performing companies will comprise the portfolio for the following year. Obviously, the number of companies comprising the portfolio can vary.

This process ensures that there is a periodic review that considers both the short (1 year) and medium (3 year) term returns of both the existing portfolio securities and the new securities. By definition, the lowest performing companies are either eliminated from or never included in the portfolio.

Diversification

An exemplary portfolio according to the present invention will have, for example, 50 stocks. The larger the number of stocks in a portfolio, the more likely the portfolio is to be diversified. However, the methodology of the present invention will not automatically generate a specified level of diversification. Therefore, in addition to the employee commitment and return on investment analyses discussed above, further criteria may be applied in the selection of securities for the portfolio to ensure that the portfolio is diversified geographically, by industry sector, etc. Yet further selection criteria may be applied to ensure that the portfolio is labour acceptable, environmentally friendly, ethical, etc., according to the concerns of the investor.

Suppose an investor wanted to build a diversified portfolio that contained companies in the following industry classifications;

pharmacy, software development, food retailing, banking, oil & gas exploration, web design, heavy manufacturing, business to business financing, commercial real estate development, and clothing retailing.

This investor would have to target a predetermined number of companies (10 for example) in each of the 10 categories. Then, the level of employee commitment in each of the 100 companies would have to be ascertained using the methods described above. Once the results were known, the investor would choose the company with the highest employee commitment in each of the 10 categories for further analysis. If no companies in a given category achieved the requisite threshold, then that category could be omitted from the portfolio, further companies in that category could be assessed, and/or alternate categories could be assessed.

Let us consider another example portfolio of securities selected according to the methods and criteria described above. With the purchase of the selected securities, a percentage relationship among the securities in the portfolio is established. In an exemplary embodiment, the percentages of stock holdings in the portfolio will be approximately equal on the initial date. Since the price of the selected securities will fluctuate over time, the relative values of securities in the portfolio, and therefore the make-up of the portfolio, will change.

The relative values of the securities in the portfolio will also change as new securities are added to the portfolio or as existing securities are removed.

Some possible features and benefits of such a portfolio (although these are not essential features of the present invention) include immediate liquidity, low Management Expense Ratio (MER), and lower investor risk.

The present invention is not limited to the selection of securities for funding a pooled investment vehicle. Securities may be selected for funding any type of segregated investment vehicle, mutual fund, registered retirement savings plans, etc.

The invention can also be embodied as a computer readable medium bearing a computer program containing instructions which, when implemented by a general purpose computer, causes the computer to carry out some or all of the various steps of the invention described herein.

While particular elements, embodiments, and applications of the present invention have been shown and described, it is understood that the invention is not to be construed in a limited sense, since modifications may be made by those skilled in the art, particularly in light of the foregoing teaching. It is therefore contemplated that the appended claims encompass such modifications and incorporate all those features that come within the spirit and scope of the invention.

What is claimed is:

1. A computer readable medium bearing a computer program containing instructions which, when implemented by a general purpose computer, cause the computer to carry out the steps of:
a) receiving data identifying companies in a user-defined first pool of publicly traded companies;
b) receiving employee commitment data for said companies in said first pool;
c) determining which companies in said first pool of companies have a level of employee commitment in excess of a predetermined threshold, wherein said companies exceeding said predetermined threshold make up a second pool of companies;
d) receiving financial data reflective of historic values of stocks of said first pool of companies and historic performance of at least one related market index;
e) from said financial data calculating an annual compound rate of return for said stocks of said first pool of companies and for said market index; and
f) determining which stocks of said companies in said first pool of companies have an annual compound rate of return exceeding said annual compound rate of return of said market index, wherein companies having stocks having an annual compound rate of return exceeding said annual compound rate of return of said market index make up a third pool of companies;
g) identifying fourth pool of companies, wherein said fourth pool of companies is made up of companies that are in both said second pool and said third pool.

2. The computer readable medium of claim 1, wherein said steps include ranking said companies in said first pool from a highest level of employee commitment to a lowest level of employee commitment.

3. The computer readable medium of claim 1, wherein said employee commitment data and said financial data are obtained from publicly available sources.

4. The computer readable medium of claim 1, further comprising receiving from the user an order to purchase one or more stocks of companies in said fourth pool.

5. The computer readable medium of claim 1, wherein said employee commitment data and said financial data are obtained from publicly available sources.

6. The computer readable medium of claim 1, wherein said step of determining which ones of said first pool of companies have a level of employee commitment in excess of a predetermined threshold is carried out by selecting a predetermined number of companies having highest values of employee commitment in said pool of companies.

7. The computer readable medium of claim 1, wherein said predetermined threshold is a user defined threshold.

8. A computer implemented method for enabling a user to create an investment portfolio comprising:
a) receiving from the user company identification data identifying a pool of companies;
b) receiving from the user employee commitment data, said employee commitment data reflective of levels of employee commitment of companies in said pool of companies;
c) receiving from the user financial data, said financial data reflective of historical values of stocks of said companies in said pool of companies and historical values of at least one corresponding market index;
d) identifying stocks of companies in said pool of companies having highest levels of employee commitment and highest historical values of stocks to form a portfolio of stocks to be owned directly by the user.

9. The computer implemented method of claim 8, wherein said financial data includes annual compound rates of return for said stocks of said companies and said at least one corresponding market index.

10. The computer implemented method of claim 8, wherein said pool of companies is ranked from companies having highest levels of employee commitment to companies having lowest levels of employee commitment.

11. The computer implemented method of claim 8, wherein said pool of companies is ranked from companies having stocks with highest annual compound rates of return to companies having lowest annual compound rates of return.

12. The computer implemented method of claim 8, wherein said stocks are identified by comparing said employee commitment data to a predetermined threshold value.

13. The computer implemented method of claim 8, wherein said stocks are identified by comparing annual compound rates of return of said pool of companies to annual compound rates of return for said at least one corresponding market index.

14. The computer implemented method of claim 8, wherein said step of identifying stocks is carried out by selecting a predetermined number of companies having at least one of highest values of employee commitment and highest historical values of stocks.

15. The computer implemented method of claim 8, wherein said step of identifying stocks is carried out by comparing said levels of employee commitment and said historical values of stocks to predetermined threshold values.

16. The computer implemented method of claim 8, further comprising receiving from the user an order to purchase one or more of said stocks in said portfolio.

17. The computer implemented method of claim 8, wherein said employee commitment data and said financial data are obtained from publicly available sources.

18. A method of utilizing a computer for selecting securities for an investment portfolio comprising:
a) defining a pool of publicly traded companies;
b) collecting data indicative of levels of employee commitment of said companies;
c) collecting financial data for said companies and for at least one relevant market index, wherein said financial data includes an annual compound rate of return for securities of said companies and for said market index;
d) selecting securities of said companies having securities with highest annual compound rates of return and highest levels of employee commitment from said pool of companies to form an investment portfolio;
wherein at least one of the steps of collecting, ranking, and selecting is carried out by a computer.

19. The method of claim 18, wherein said group of publicly traded companies is selected from at least one of the New York Stock Exchange, NASDAQ, the Toronto Stock Exchange, the London Stock Exchange, and the Tokyo Stock Exchange.

20. The method of claim 18, further comprising a step of comparing said data indicative of levels of employee commitment to a predetermined threshold.

21. The method of claim 18, wherein said selecting step comprises selecting a predetermined number of said securities.

22. The method of claim 18, wherein said method further includes purchasing at least some of said group of selected securities to form a group of purchased securities.

23. The method of claim 22, wherein percentages of said purchased securities holdings are approximately equal.

24. The computer implemented method of claim 18, wherein said employee commitment data and said financial data are obtained from publicly available sources.

25. A computer-readable medium bearing a computer program containing instructions which, when implemented by a general purpose computer, cause the computer to carry out the steps of:
a) receiving data indicative of levels of employee commitment of companies in a pool of companies;
b) receiving financial data for said companies and for at least one relevant market index, wherein said financial data includes an average annual compound rate of return for securities of said companies and for said market index;
c) ranking said companies according to said data indicative of levels of employee commitment and according to said financial data, to form a group of ranked companies; and
d) selecting at least some of said securities of said group of ranked companies to form an investment portfolio;
wherein at least one of the steps of collecting, ranking, and selecting is carried out by a computer.

26. The method of claim 25, wherein said pool of companies is selected from at least one of the New York Stock Exchange, NASDAQ, the Toronto Stock Exchange, the London Stock Exchange, and the Tokyo Stock Exchange.

27. The method of claim 25, further comprising a step of comparing said data indicative of levels of employee commitment to a predetermined threshold.

28. The method of claim 25, wherein said selecting comprises selecting a predetermined number of said securities.

29. The method of claim 25, wherein said method further includes purchasing at least some of said group of selected securities to form a group of purchased securities.

30. The method of claim 25, wherein percentages of said purchased securities holdings are approximately equal.

31. The method of claim 25, wherein said employee commitment data and said financial data are obtained from publicly available sources.

32. The method of claim 25, wherein in said selecting step securities of companies having highest levels of employee commitment and securities having highest levels of average annual compound rate of return are selected.

33. A method of utilizing a computer for selecting securities for an investment portfolio comprising:
a) defining a pool of publicly traded companies;
b) determining a level of employee commitment of each of said companies in said pool;
c) defining a threshold level of employee commitment;
d) out of said pool of companies, selecting those companies having a level of employee commitment exceeding said threshold;
e) determining an annual compound rate of return for each of said companies in said pool;
f) comparing said average annual compound rates of return of said companies to an average annual compound rate of return for a corresponding market index;
g) identifying ones of said selected companies having an average annual compound rate of return that exceeds said average annual compound rate of return of said corresponding market index; and
h) selecting stocks of said identified companies for inclusion in said investment portfolio; wherein at least one of the steps of collecting, ranking, and selecting is carried out by a computer.

34. The method of claim 33, wherein a 1-year average annual compound rate of return and a 3-year average annual compound rate of return is calculated for each one of said selected companies, and wherein said 1-year and said 3-year average annual compound rate of return are compared to average annual compound rates of return of a corresponding market index.

35. The method of claim 33, wherein said pool of publicly traded companies includes companies traded on one or more of: the NYSE, the Toronto Stock Exchange, the NASDAQ, the Tokyo Stock Exchange and the London Stock Exchange.

36. The method of claim 33, wherein said level of employee commitment is measured by conducting interviews of a representative sample of employees of each one of said companies in said pool of companies, and wherein said interviews are carried out in person, by telephone, by email, or online.

37. The method of claim 33, wherein said level of employee commitment is measured by having a representative, random sample of employees of each one of said companies in said pool of companies fill out a survey, wherein said survey is one of a paper survey, an email survey, and an online survey.

38. The method of claim 33, wherein said level of employee commitment is measured by having a representative sample of employees of each one of said companies in said pool of companies answer one or more of the following questions:
(a) Are you held accountable for the decisions you make?;
(b) Do you receive a formal performance appraisal at least once per year?;
(c) Does your manager actively solicit input from others in the organization before writing your performance appraisal?;
(d) If you do not agree with your manager's evaluation of your performance, is there an appeal process?;
(e) Do you get a bigger pay increase if your performance is better than the average employee?;
(f) Are there established pay grades using a recognized rating system?;
(g) Are bonuses paid below the manager/supervisor level?;
(h) Are you satisfied with the health benefits that you receive?;
(i) Is there a pension plan?;
(j) Is ‘fitting into the company culture’ an important consideration when recruiting new employees?;
(k) Are the majority of promotional opportunities filled internally?;
(I) Are all qualified employees given the opportunity to be interviewed?;
(m) Are unsuccessful candidates provided with constructive feedback?;
(n) Is professional development discussed during the performance appraisal process?;
(o) Is there a clear process/policy for applying for professional development opportunities?;
(p) Do you receive at least 8 hours of professional development per year?;
(q) Do employees receive information about company performance (e.g. sales, profit, challenges, new opportunities, etc.)?;
(r) Do you have regular meetings (at least twice per year) with your senior manager at which you can ask questions?;
(s) Does the company have formally stated ethical values?;
(t) Does senior management abide by these ethical values?;
(u) Are new employees coached on the importance of following the company culture?;
(v)Does your boss treat you with respect?;
(w) Do you receive paid time off to take your dependent children to medical appointments?;
(x) Are you proud to work for this company?; and
(y) If senior management makes a promise to the employees, do they keep it?.

39. The method of claim 33, wherein said level of employee commitment is measured by measuring Performance Management, Pay and Benefits, Promotions, Professional Development, Communication, and Working Environment practices of each of said companies in said pool.

40. The method of claim 33, wherein for any given one of said companies in said pool of companies, employee commitment is based solely on data reflective of opinions of employees of that company.

41. The method of claim 33, wherein said portfolio contains stocks of approximately 50 companies.

42. The method of claim 33, wherein said portfolio is reviewed periodically.

43. The method of claim 33, wherein said level of employee commitment and said average annual compound rate of return are determined by reference to publicly available sources.

44. The method of claim 33, further comprising the step of creating an investment account containing said portfolio of stocks.
